(19) United States
(12) Patent Application Publication
(10) Pub. No.: US 2026/0244609 A1
(43) Pub. Date: Aug. 20, 2026

(54) DATA QUERY METHOD, DEVICE, SYSTEM, AND STORAGE MEDIUM

(71) Applicant: CLOUD INTELLIGENCE ASSETS HOLDING (SINGAPORE) PRIVATE LIMITED, Singapore (SG)

(72) Inventors: Adong FAN, Hangzhou City (CN); Yunlei MA, Hangzhou City (CN); Hanjie GU, Hangzhou City (CN); Bin WANG, Hangzhou City (CN); Zhen WANG, Hangzhou City (CN); Yue QU, Hangzhou City (CN)

(21) Appl. No.: 19/156,349

(22) PCT Filed: Feb. 29, 2024
(86) PCT No.: PCT/CN2024/079206

§ 371 Date: Aug. 13, 2025

(30) Foreign Application Priority Data
Mar. 8, 2023 (CN) 202310239766.4

(51) Int. Cl. G06F 16/22; G06F 16/2452; G06F 16/248

(52) U.S. Cl. CPC G06F 16/221; G06F 16/24524; G06F 16/248

(57) ABSTRACT

Embodiments of the present disclosure provide a data query method, a device, a system, and a storage medium. In this embodiment of the present disclosure, a data schema of target data may be constructed via a query request; and the target data is assembled according to the constructed data schema. In this way, based on the query request and the data schema, a computing operation can be performed on the target data stored in the constructed data schema to obtain a query result, thereby implementing schema on read. This data query manner does not require data to be written according to a fixed data schema, which can improve data flexibility. In addition, schema on read can satisfy computation and analysis requirements and improve data computing capability of the database.

This application claims priority to Chinese Patent Application No. 202310239766.4, filed with the China National Intellectual Property Administration on Mar. 8, 2023 and entitled “DATA QUERY METHOD, DEVICE, SYSTEM, AND STORAGE MEDIUM”, which is incorporated herein by reference in its entirety.

### TECHNICAL FIELD

This application relates to the field of database technologies, and in particular, to a data query method, a device, a system, and a storage medium.

### BACKGROUND

Accompanied with the development of informatization technologies, data increases in a burst manner, and databases are continuously developed and used. Databases, serving as the core and foundation of information technologies, carry a large amount of key data. Modern databases and various storage and analysis systems generally use a structured query language (Structured Query Language, SQL) to perform various aggregation, joint analysis, and the like on data, and the use of the SQL requires the data to be analyzed to conform to a schema (Schema) of a standardized relational data model.

In some solutions, the schema (Schema) of data needs to be predefined, and then the data is written into a database according to the defined schema. Therefore, the data stored in the database all complies with the predefined schema, and the data flexibility is relatively low. In some other solutions, a database system does not have a strict requirement on the data format during data writing, but such a system does not have an SQL analysis capability. Therefore, how to improve the data computing capability of a database while ensuring the data flexibility becomes a technical problem to be urgently resolved in this field.

### SUMMARY

Various aspects of the present application provide a data query method, a device, a system, and a storage medium, to improve the data computing capability of the system while ensuring the data flexibility.

An embodiment of the present application provides a data query method, including:
obtaining a query request, where data of a data source to be queried corresponding to the query request is stored in a non-fixed schema;
constructing, based on the query request, a data schema of data to be queried corresponding to the query request;
reading, from the data source to be queried, the data to be queried;
assembling, according to the data schema, the data to be queried, to obtain data stored according to the data schema; and
performing, based on the data schema and the query request, a computing operation on the data stored according to the data schema, to obtain a query result.

An embodiment of this application further provides a database system, including: a query engine and a data source; the data source including: a data source to be queried corresponding to a query request, where data of the data source to be queried is stored in a non-fixed schema; and
the query engine being configured to perform the steps in the foregoing data query method.

An embodiment of this application further provides a computing device, including: a memory and a processor, where the memory is configured to store a computer program;
the processor is coupled to the memory and configured to execute the computer program to perform the steps in the foregoing data query method.

An embodiment of this application further provides a computer-readable storage medium storing computer instructions, where the computer instructions, when executed by one or a plurality of processors, cause the one or the plurality of processors to perform the steps in the foregoing data query method.

In the embodiments of this application, a data schema of data to be queried may be constructed through a query request; and the data to be queried is assembled according to the constructed data schema. In this way, a computing operation can be performed, based on the query request and the data schema, on the data to be queried stored in the constructed data schema, to obtain a query result, thereby implementing schema on read. This data query manner does not require data to be written according to a fixed data schema, which can improve data flexibility. In addition, the schema on read can satisfy computing and analysis requirements, improve data computing capability of the database, and therefore, improve the computing capability of the database while ensuring the data flexibility of the database.

### BRIEF DESCRIPTION OF DRAWINGS

The accompanying drawings described herein are used to provide a further understanding of the present application, and form part of the present application. Exemplary embodiments of the present application and descriptions thereof are used to explain this application, and do not constitute any inappropriate limitation to this application. In the accompanying drawings:

FIG. 1 and FIG. 2 are schematic structural diagrams of a database system according to an embodiment of the present application;

FIG. 3 and FIG. 4 are schematic flowcharts of a data query method according to an embodiment of the present application; and

FIG. 5 is a schematic structural diagram of a computing device according to an embodiment of the present application.

### DETAILED DESCRIPTION

To make the objectives, technical solutions, and advantages of the present application clearer, the technical solutions of the present application will be clearly and completely described below with reference to specific embodiments of the present application and corresponding accompanying drawings. Apparently, the described embodiments are only some embodiments rather than all the embodiments of the present application. All other embodiments obtained by a person of ordinary skill in the art based on the embodiments of the present application without creative efforts shall fall within the protection scope of the present application.

In some embodiments of the present application, a data schema of data to be queried may be constructed through a query request; and the data to be queried is assembled according to the constructed data schema. In this way, a computing operation can be performed, based on the query request and the data schema, on the data to be queried stored in the constructed data schema, to obtain a query result, thereby implementing schema on read. This data query manner does not require data to be written according to a fixed data schema, which can improve data flexibility. In addition, the schema on read can satisfy computing and analysis requirements, improve data computing capability of the database, and therefore, improve the computing capability of the database while ensuring the data flexibility of the database.

The following describes the technical solutions provided in various embodiments of the present application in detail with reference to the accompanying drawings.

It should be noted that: a same numeral represents a same object in the following accompanying drawings and embodiments. Therefore, once an object is defined in one accompanying drawing or embodiment, the object does not need to be further discussed in subsequent accompanying drawings and embodiments.

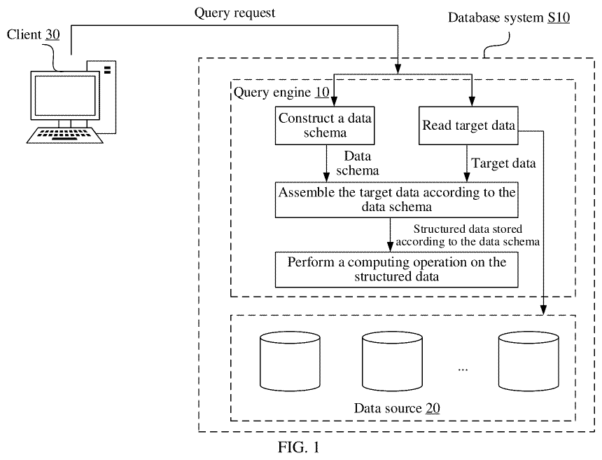

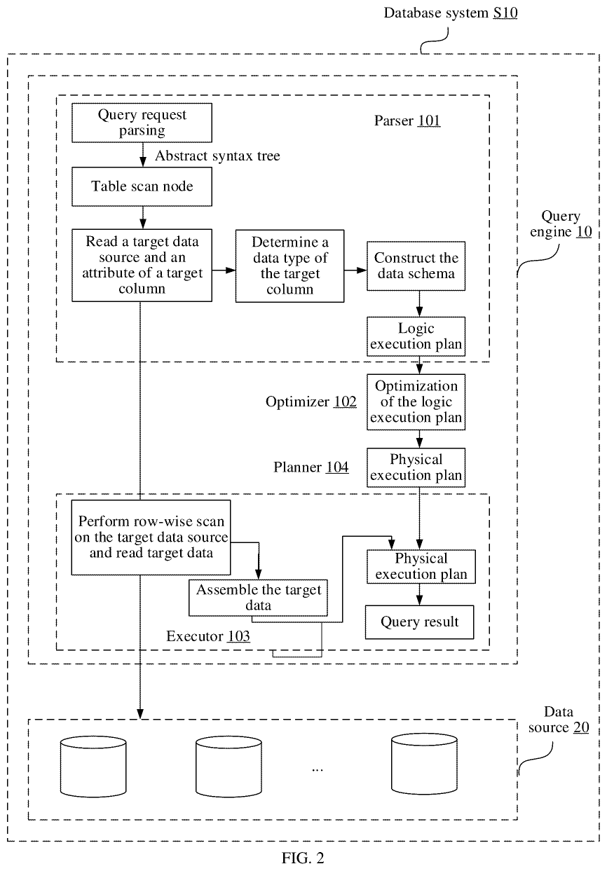

FIG. 1 and FIG. 2 are schematic structural diagrams of a database system according to an embodiment of the present application. As shown in FIG. 1 and FIG. 2, the database system S10 includes: a query engine 10 and a data source 20.

The query engine 10 refers to a software module, an application program, a service, or a physical device that provides a query function based on a data source. The query engine 10 provided in this embodiment of the present application may be implemented as an online analytical processing (Online Analytical Processing, OLAP) system.

As shown in FIG. 2, the query engine 10 may include: a parser 101, an optimizer 102, and an executor 103. The parser 101, the optimizer 102, and the executor 103 may be located in a same physical machine, or may be deployed in different physical machines.

The data source 20 refers to a database or a database server used by a database application program. The data source 20 is a tool configured to store data, and may be a database, or may be a storage file, for example, a data table having rows and columns. There may be one or a plurality of data sources 20. The “plurality of” means two or more than two. Different data sources may be deployed on a same storage device, or a same data source may be distributed on different storage devices.

In this embodiment, to improve the flexibility of data stored in the data source 20, the database system does not impose a requirement on the data schema of data written into the data source 20. Correspondingly, the query engine 10 does not need to define a data schema (Schema) in advance, there is no need to write data into the data source 20 according to a predefined data schema, and data can be written into the data source 20 flexibly.

In this embodiment, the data schema (Schema) is used for describing a storage manner of the data in the data source in a particular data model. For a data source of a relational data model, the data schema is used for describing a table structure in the data source, for example, a quantity of columns of a table, an attribute of a column, and a data type of a column. The data type is an attribute of data, and tells a compiler how to use the data. The data type may include: an integer type, a floating-point number type, a fixed-point number type, a floating-point type, a character string type, a binary type, or the like. The integer type includes types such as tinyint, smallint, mediumint, int, and bigint. The floating-point number type includes types such as float and double, and the fixed-point number type may include decimal or the like. The character string type may include: char, varchar, binary, varbinary, blob, text, enum, set, or the like. The binary type may include: bit, binary, varbinary, or the like.

During an actual application, when querying data in a data source, a user often needs to perform a computing operation on the data, for example, perform an aggregation operation operation on the data or perform joint analysis on the data. Data participating in the computing operation needs to conform to a uniform data schema, so that a joint computing operation can be performed on the data. Complex computing cannot be directly performed on data stored in a non-fixed schema (Schema) in the data source 20. The data stored in the non-fixed schema refers to data that is not stored according to a predefined data schema, or data that is directly written into the data source 20 without defining a data schema in advance. In this embodiment, the data stored in the non-fixed schema may be key-value pair (key-value, KV) data. The data stored in the non-fixed schema may also be stored in a data table, and metadata of different data tables may be the same or may be different. The metadata of the data table includes: a quantity of columns of the data table, a column name (which may also be referred to as an attribute of a column), a data type of a column, or the like.

In this embodiment, to implement computation on data stored in the non-fixed schema while ensuring the flexibility of data storage, a method for performing data query by automatic schema on read is provided. The schema on read refers to constructing, when data stored in a non-fixed schema is read, a data schema of data to be queried. The following illustratively describes the data query manner provided in the embodiments of the present application.

In this embodiment, the database system S10 may provide a database query service for a user. The database system S10 may provide various query services such as a simple query service, a union query service, and a join query service, but this application is not limited thereto. When needing to perform data query, a user may send a query request to the database system S10 by a client 30. For example, the database system S10 may provide a query entrance oriented toward users, for the client 30 to send a query request. Optionally, the query entrance provided by the database system S10 to the user may be a web page, an application page, a command window, or the like.

Further, when the query request reaches the database system S10, the query engine 10 may receive the query request sent by the client 30. The query request may be a join query request for various operations, including but not limited to: a selection query, a projection query, a union query, an aggregation query, or the like. The query request may include: an identifier of a data source to be queried, an identifier of data to be queried, a computing type for the data to be queried, or the like. The computing type of the data to be queried may be an aggregation operation, and/or association analysis, or the like. In this embodiment of this application, a programming language of the query request is not limited. For example, the query request may be a query request written in a structured query language (Structured Query Language, SQL), a linkcache query language (Linkcache query language, LQL), a domain specified language (Domain Specified Language, DSL), or the like.

Because performing computational analysis on data requires the data to conform to a specific data schema, and raw data in the data source is stored in a non-fixed schema, the query engine 10 cannot directly perform computation on the raw data read from the data source. To resolve the problem, in this embodiment, the query engine 10 may construct, based on the query request, a data schema of the data to be queried corresponding to the query request. The data to be queried is data that the query request requests to query.

In some embodiments, as shown in FIG. 2, the query engine 10 may parse the query request to obtain an abstract syntax tree (Abstracted Syntax Tree, AST).

Specifically, the parser 101 in the query engine may perform lexical analysis and syntax parsing on the query request to obtain the abstract syntax tree, and perform error detection on a statement of the query request in this process to ensure that an input request statement has no syntax and lexical errors. For example, it is detected whether a keyword is incorrectly spelled, whether there is a redundant punctuation, whether an entire statement is valid, or the like.

Further, the parser 101 may construct, based on the abstract syntax tree, the data schema of the data to be queried. Specifically, the parser 101 may determine, based on the abstract syntax tree, a data source to be queried and an attribute of a column to be queried. Data stored in the column to be queried includes the data to be queried. In some embodiments, the data stored in the column to be queried is the data to be queried. Specifically, the parser 101 may obtain a table scan node (Table Scan Node) from the abstract syntax tree, and read, from the table scan node, the data source to be queried and the attribute of the column to be queried. The attribute of the column to be queried is a column name of the column to be queried, may be understood as an attribute of the data stored in the column to be queried, is used for reflecting specific information of the data, and may also be understood as a key in a key-value pair (Key-Value, KV). If data objects corresponding to data stored in columns to be queried are different, the attributes of the columns to be queried are different. For example, in some embodiments, the data stored in a column to be queried is information about a commodity, the attribute of the column to be queried may be a commodity name, model, quantity, price, or the like. Still for example, if the data stored in a column to be queried is log data, the attribute of the column to be queried may be a time stamp, an attribute of an object to which the log data belongs, or the like.

Further, the parser 101 may further determine a data type of the column to be queried. In some embodiments, the parser 101 may determine, based on the attribute of the column to be queried, the data type of the column to be queried. For example, the query engine 10 pre-stores a corresponding relationship between attributes and data types. Correspondingly, the parser 101 may use the attribute of the column to be queried to perform matching in the corresponding relationship between attributes and data types, to obtain the data type corresponding to the attribute of the column to be queried as the data type of the column to be queried. The corresponding relationship between attributes and data types may be obtained by analyzing another data table stored according to a data schema, or may be flexibly set according to experience, or the like. For example, a time stamp attribute may be set to a bigint type, and another attribute may be set to a varchar type, and so on.

In some other embodiments, the parser 101 may perform semantic analysis on the query request to obtain a clause included in the query request; and may determine, based on the clause included in the query request, a function and/or an operation expression operating on the column to be queried. Whether it is a function, or an operation expression, or both a function and an operation expression operating on the column to be queried in the clause is specifically determined by a query requirement of a user. The operation expression may include an operand and an operator. The operand is an entity on which the operator acts.

The function has a requirement on a data type of an input parameter (referred to as an input parameter type for short). For different functions, compatible input parameter types are different. For example, if the function is a summation function “sum”, the input parameter type compatible with the summation function “sum” is a number type, such as an integer type or a floating point type. Still for example, the function is a trigonometric function (for example, a cosine function “cos”), and the input parameter type compatible with the trigonometric function is a floating point type.

The operation expression also has a requirement on the data type of a compatible operand. For example, for the operation expression of a comparison operation such as “not equal to”, “less than”, or “greater than”, the data type of the column to be queried is determined by a data type of another operation operand in the operation expression of the comparison operation. For example, if another operand in the expression of the comparison operation is of a character string type, the column to be queried is of a character string type; and if another operand in the expression of the comparison operation is of a number type, the column to be queried is of a number type.

Still for example, for an operation expression corresponding to an arithmetic calculation operation, the data type of the column to be queried in the operation expression may be determined by an operator. For example, for a division operator “/” and a remainder operator “%”, the compatible data type of operands is an integer type, and so on.

Based on this, in this embodiment, the data type of the column to be queried may also be determined based on a function and/or an operation expression that operates on the column to be queried and that is included in a clause of the query request.

Specifically, the clause of the query request may include: a function and/or an operation expression operating on the column to be queried. A quantity of functions included in a clause and/or a quantity of operators included in a clause are/is determined by a query requirement of a user. Correspondingly, the query engine 10 may determine an input parameter type compatible with the function operating on the column to be queried; and determine, based on the input parameter type compatible with the function, a data type of the column to be queried. And/or, the query engine 10 may determine, based on the operation expression operating on the column to be queried, a data type of the column to be queried.

A function may be compatible with one or a plurality of input parameter types. Certainly, an operation expression may also be compatible with one or a plurality of data types. The “plurality of” means two or more than two. In this embodiment, specifically, the query engine 10 pre-stores a corresponding relationship between function names and input parameter types, and a corresponding relationship between operators and data types of operands. Correspondingly, when the parser 101 determines an input parameter type compatible with the function operating on the column to be queried, the parser 101 may match a function name of the function in the corresponding relationship between function names and input parameter types, to determine the input parameter type compatible with the function operating on the column to be queried.

Certainly, when the parser 101 determines, based on the operation expression operating on the column to be queried, a data type of the column to be queried, the parser 101 may match the operator in the corresponding relationship between operators and data types of operands, to obtain the data type compatible with the operator operating on the column to be queried. Or, the data type of the column to be queried may be determined based on a data type of another operand in the operation expression operating on the column to be queried.

In the foregoing embodiments and the following embodiments, if the query request includes only a function operating on the column to be queried, only the step of determining an input parameter type compatible with the function operating on the column to be queried is performed. Correspondingly, when determining the data type of the column to be queried, the data type of the column to be queried may be determined based on the input parameter type compatible with the function operating on the column to be queried.

There may be one or a plurality of functions operating on a same column to be queried. When a plurality of functions operate on the same column to be queried, data types compatible with the plurality of functions may be partially the same, an intersection type of the input parameter types compatible with the plurality of functions may be determined according to the input parameter types respectively corresponding to the plurality of functions operating on the same column to be queried; and the data type of the column to be queried may be determined based on the intersection type of the input parameter types compatible with the plurality of functions.

Specifically, if the input parameter types compatible with the plurality of functions have one intersection type, it is determined that the intersection type is the data type of the column to be queried. If the input parameter types compatible with the plurality of functions have a plurality of intersection types, an intersection type whose use order ranks the first may be selected from the plurality of intersection types based on preset use orders of the data types as the data type of the column to be queried.

If the query request includes only an operation expression operating on the column to be queried, only the foregoing step of determining, based on the operation expression operating on the column to be queried, the data type of the column to be queried is performed. Correspondingly, when determining the data type of the column to be queried, the data type of the column to be queried may be determined based on the operation expression operating on the column to be queried.

There may be one or a plurality of operation expressions operating on the same column to be queried. When a plurality of operation expressions operate on the same column to be queried, data types determined for the plurality of operation expressions may be partially the same, an intersection type of the data types determined for the plurality of operation expressions may be determined based on the data types respectively determined for the plurality of operation expressions operating on the same column to be queried; and the data type of the column to be queried may be determined based on the intersection type of the data types respectively obtained for the plurality of operation expressions.

Specifically, if the data types determined for the plurality of operation expressions have one intersection type, it is determined that the intersection type is the data type of the column to be queried. If the data types determined for the plurality of operation expressions have a plurality of intersection types, an intersection type whose use order ranks the first may be selected from the plurality of intersection set types based on preset use orders of the data types as the data type of the column to be queried.

If the query request includes a function and an operation expression that operate on the column to be queried, the foregoing step of determining an input parameter type of the function operating on the column to be queried and the foregoing step of determining, based on the operation expression operating on the column to be queried, a data type of the column to be queried are performed. Correspondingly, when determining the data type of the column to be queried, the data type of the column to be queried may be determined based on the input parameter type of the function and the data type of the column to be queried that is determined based on the operation expression.

There may be one or a plurality of functions and one or a plurality of operation expressions operating on the same column to be queried. Correspondingly, an intersection type between the input parameter type(s) compatible with the function(s) operating on the same column to be queried and the foregoing data type(s) of the column to be queried determined based on the operation expression(s) may be determined; and the data type of the column to be queried may be determined based on the intersection type.

After determining the data type of the column to be queried, the parser 101 may construct, based on storage distribution information of the data source to be queried, the attribute of the column to be queried, and the data type of the column to be queried, the data schema of the data to be queried. The data schema may be in a form of a data table. The data schema includes: the storage distribution information of the data source to be queried, the attribute of the column to be queried, and the data type of the column to be queried. The storage distribution information of the data source to be queried is used for indicating a storage location of the data source to be queried, and may be pre-stored in the query engine 10.

In this embodiment of the present application, the query engine 10 may further read, from the data source to be queried, the data to be queried. Specifically, as shown in FIG. 2, the query engine 10 may obtain a table scan node from an abstract syntax tree corresponding to the query request; and read, from the table scan node, the attribute of the column to be queried. Further, the query engine 10 may scan, in a row scanning manner and based on the attribute of the column to be queried, data of the data source to be queried; read, from the scanned data row, data whose attribute matches the attribute of the column to be queried, as the data to be queried. The process may be performed by the parser 101 of the query engine 10.

Specifically, the query engine 10 may match the attribute of the column to be queried with the attribute included in the scanned data row, and if the attribute included in the scanned data row matches the attribute of the column to be queried, the query engine 10 reads the attribute and an attribute value corresponding to the attribute from the scanned data row, until traversing of the data source to be queried is completed. When traversing of the data source to be queried is completed, all attributes and attribute values that are read are the data to be queried.

Because computation on the data to be queried requires that the data to be queried conforms to a particular data schema, the query engine 10 may assemble the data to be queried according to the constructed data schema, so that the data to be queried is stored according to the constructed data schema, that is, data stored according to the constructed data schema is obtained. The data schema of the assembled data to be queried is the same as the foregoing constructed data schema.

Further, the query engine 10 may perform, based on the constructed data schema and the query request, a computing operation on the data stored according to the constructed data schema (that is, the assembled data to be queried), to obtain a query result. The type of the computing operation is determined by the query request. If the query request is an aggregation query, the computing operation is an aggregation operation, for example, determining an average value, a maximum value, or a minimum value. If the query request is a join query, the computing operation may be a join operation or the like.

In this embodiment, a data schema of data to be queried may be constructed via a query request; and the data to be queried may be assembled according to a constructed data schema. In this way, a computing operation can be performed, based on the query request and the data schema, on the data to be queried stored in the constructed data schema, to obtain a query result, thereby implementing schema on read. This data query manner does not require data to be written according to a fixed data schema, which can improve data flexibility. In addition, the schema on read can satisfy computation and analysis requirements and improve data computing capability of the database, therefore, improving the computing capability of the database while ensuring the data flexibility of the database.

In some embodiments of the present application, when a computing operation is performed, based on the data schema constructed based on the above and the query request, on the data stored according to the constructed data schema (that is, the assembled data to be queried), the query engine 10 may generate an execution plan based on the constructed data schema and the abstract syntax tree corresponding to the query request, and perform the computing operation, based on the execution plan, on data stored according to the constructed data schema (that is, the data to be queried assembled according to the constructed data schema), to obtain the query result.

Specifically, the execution plan may include: a logic execution plan and a physical execution plan. The parser 101 in the query engine 10 may bind, based on the constructed data schema, nodes of the abstract syntax tree with metadata of the table described by the data schema, to obtain a logic execution plan. The metadata of the table may include: an attribute of the column to be queried (that is, a column name), a data type of the column to be queried, or the like. Specifically, the parser 101 may sequentially check the nodes of the abstract syntax tree, and bind the metadata describing the table in the constructed data schema to the nodes of the abstract syntax tree to obtain the logic execution plan.

In some embodiments, the optimizer 102 may optimize the logic execution plan. The optimizer 102 may be a rule-based optimizer (Rule-based Optimizer, RBO) or a cost-based optimizer (Cost-based Optimizer, CBO).

Further, a planner (Planner) 104 in the query engine 10 may generate the physical execution plan based on the storage distribution information of the data source to be queried and the logic execution plan. Further, the executor 103 in the query engine 10 may perform the corresponding computing operation, based on the physical execution plan, on the data stored according to the constructed data schema (that is, the data to be queried assembled according to the constructed data schema), to obtain the query result. The foregoing step of reading, from the data source to be queried, the data to be queried may be performed by the executor 103.

There may be one or a plurality of executors 103. The “plurality of” means two or more than two. The plurality of executors may be deployed on a same computing node, or may be deployed on different computing nodes. The planner 104 may select a target executor from the plurality of executors based on the storage distribution information of the data source to be queried, and deliver the physical execution plan to a computing node in which the target executor is located. Correspondingly, the target executor in the computing node may perform the corresponding computing operation, based on the physical execution plan, on the data stored according to the constructed data schema (that is, the data to be queried assembled according to the constructed data schema), to obtain the query result.

Optionally, the planner 104 may select a target executor from the plurality of executors based on a load balancing policy. Or, in some embodiments in which storage and computing are coupled, the computing node stores a data source. Based on this, the planner 104 may determine, based on the storage distribution information of the data source to be queried, the computing node where the data source to be queried is located; and deliver the physical execution plan to the executor in the computing node where the data source to be queried is located. The executor in the computing node where the data source to be queried is located is the target executor.

The target executor may read, based on the abstract syntax tree, the data to be queried from the data source to be queried, and assemble the data to be queried based on the data schema constructed in the foregoing embodiments, to obtain the data stored according to the constructed data schema. Further, the target executor may perform the computing operation corresponding to the physical execution plan, based on the physical execution plan, on the data stored according to the constructed data schema (that is, the data to be queried assembled according to the constructed data schema), to obtain the query result.

After obtaining the query result, the query engine 10 may return the query result to the client 30. The client 30 may output the query result.

In some embodiments of this application, to reduce the memory consumption of a node where the query engine is located, a life cycle of the constructed data schema may be bound with a current query request, and after the query result corresponding to the query request is obtained, the constructed data schema is destroyed, and when a new query request arrives, a new data schema is constructed in the foregoing data access manner, to implement automatic schema on read.

In addition to the foregoing system embodiments, an embodiment of this application further provides a data query method. The following illustratively describes the data query method provided in the embodiment of this application.

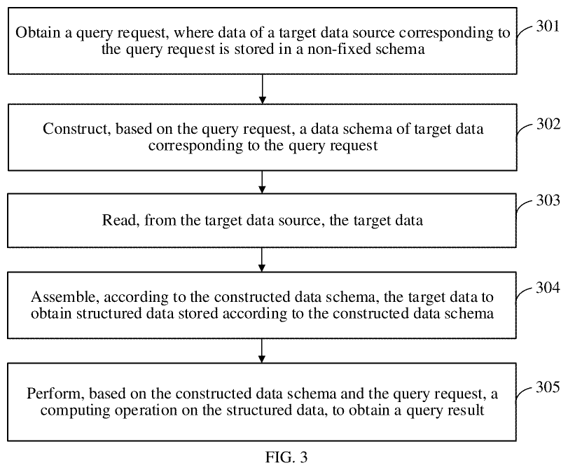

FIG. 3 is a schematic flowchart of a data query method according to an embodiment of this application. As shown in FIG. 3, the data query method includes the following steps.

301: Obtain a query request, where data of a data source to be queried corresponding to the query request is stored in a non-fixed schema.

302: Construct, based on the query request, a data schema of data to be queried corresponding to the query request.

303: Read, from the data source to be queried, the data to be queried.

304: Assemble, according to the constructed data schema, the data to be queried, to obtain data stored according to the constructed data schema.

305: Perform, based on the constructed data schema and the query request, a computing operation on the data stored according to the constructed data schema, to obtain a query result.

In this embodiment, to improve the flexibility of data stored in the data source, the database system does not impose a requirement on the data schema of data written into the data source. Correspondingly, a data schema (Schema) may not be defined in advance, there is no need to write data into the data source according to a predefined data schema, and data can be written into the data source flexibly. For descriptions about the data schema, reference can be made to related content in the foregoing system embodiments, and details are not described herein again.

During an actual application, when querying data in a data source, a user often needs to perform a computing operation on the data, for example, perform an aggregation operation operation on the data or perform joint analysis on the data. Data involved in the computing operation needs to conform to a uniform data schema, so that a joint computing operation can be performed on the data. Complex computing cannot be directly performed on data stored in a non-fixed schema (Schema) within the data source.

In this embodiment, to implement computation of the data stored in the non-fixed schema while ensuring the flexibility of data storage, a method for performing data query by automatic schema on read is provided. The schema on read refers to constructing, when data stored in a non-fixed schema is read, a data schema of data to be queried. The following illustratively describes the data query manner provided in the embodiments of the present application.

Because performing computational analysis or the like on data requires the data to conform to a particular data schema, while raw data in the data source is stored in a non-fixed schema, for the query request obtained in step 301, in step 302, a data schema of the data to be queried may be constructed based on the query request. The data to be queried is data that the query request requests to query.

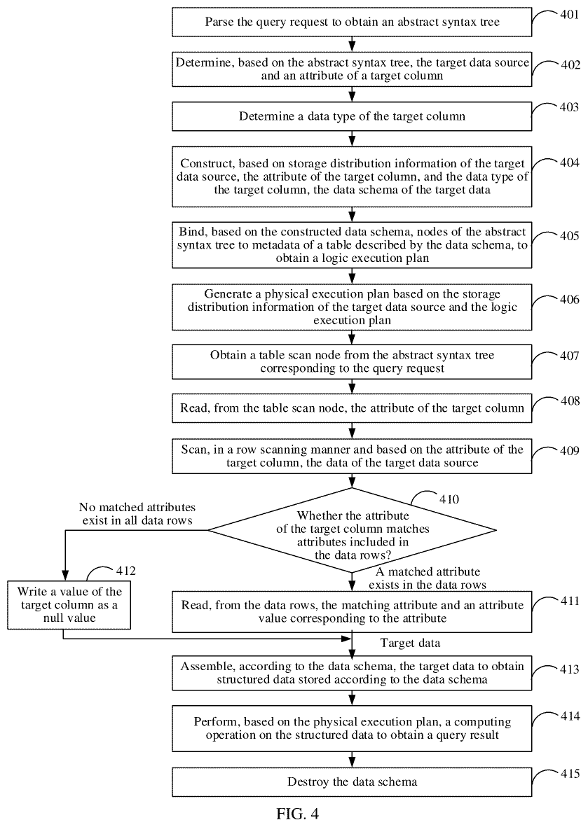

In some embodiments, step 302 may be implemented as step 401 to step 404 in FIG. 4. As shown in step 401, the query request may be parsed to obtain an abstract syntax tree.

Specifically, lexical analysis and syntax parsing may be performed on the query request to obtain the abstract syntax tree, and error detection may be performed on a statement of the query request in this process to ensure that an input request statement has no syntax and lexical errors. For example, it is detected whether a keyword is incorrectly spelled, whether there is a redundant punctuation, whether an entire statement is valid, or the like.

Further, the data schema of the data to be queried may be constructed based on the abstract syntax tree. Specifically, as shown in step 402, the data source to be queried and an attribute of a column to be queried may be determined based on the abstract syntax tree. Data stored in the column to be queried is the data to be queried. For example, a table scan node may be obtained from the abstract syntax tree, and the data source to be queried and the attribute of the column to be queried may be read from the table scan node.

Further, in step 403, a data type of the column to be queried may be determined. In some embodiments, the data type of the column to be queried may be determined based on the attribute of the column to be queried. For example, a corresponding relationship between attributes and data types may be stored in advance. Correspondingly, matching may be performed in the corresponding relationship between attributes and data types by using the attribute of the column to be queried, to obtain the data type corresponding to the attribute of the column to be queried as the data type of the column to be queried. The corresponding relationship between attributes and data types may be obtained by analyzing another data table stored according to a data schema, or may be flexibly set according to experience, or the like.

In some other embodiments, semantic analysis may be performed on the query request to obtain a clause included in the query request; and a function and/or an operation expression operating on the column to be queried may be determined based on the clause included in the query request. Whether a function, or an operator, or both a function and an operation expression operate on the column to be queried in the clause is specifically determined by a query requirement of a user.

The function has a requirement on a data type of an input parameter (referred to as an input parameter type for short). For different functions, compatible input parameter types are different. For an operator, the operator also has a requirement on the data type of the operand. Based on this, in this embodiment, the data type of the column to be queried may also be determined based on a function and/or an operation expression that operates on the column to be queried and that is included in a clause of the query request.

Specifically, the clause of the query request may include: a function and/or an operation expression operating on the column to be queried. A quantity of functions included in a clause and/or a quantity of operation expressions included in a clause are/is determined by a query requirement of a user. Correspondingly, the input parameter type compatible with the function operating on the column to be queried may be determined, and the data type of the column to be queried may be determined based on the input parameter type compatible with the function; and/or, the data type compatible with an operand of an operator operating on the column to be queried may be determined based on the operation expression operating on the column to be queried. For specific implementations of the step, reference can be made to related content in the foregoing embodiments, and details are not described herein again.

After determining the data type of the column to be queried, in step 404, the data schema of the data to be queried may be constructed based on storage distribution information of the data source to be queried, the attribute of the column to be queried, and the data type of the column to be queried. The data schema may be in a form of a data table. The data schema includes: the storage distribution information of the data source to be queried, the attribute of the column to be queried, and the data type of the column to be queried. The storage distribution information of the data source to be queried is used for indicating a storage location of the data source to be queried, and may be pre-stored in the query engine.

In this embodiment of the present application, in step 303, the data to be queried may further be read from a data source to be queried. A specific implementation of step 303 may be step 407 to step 411 in FIG. 4. Specifically, as shown in FIG. 4, in step 407, a table scan node may be obtained from an abstract syntax tree corresponding to the query request. In addition, in step 408, the attribute of the column to be queried is read from the table scan node. Further, in step 409, data of the data source to be queried may be scanned in a row scanning manner based on the attribute of the column to be queried; data whose attribute matches the attribute of the column to be queried may be read from the scanned data row as the data to be queried.

Specifically, as shown in step 410 of FIG. 4, the attribute of the column to be queried may be matched with the attribute included in the scanned data row, and if the attribute included in the scanned data row matches the attribute of the column to be queried, the attribute and an attribute value corresponding to the attribute are read from the scanned data row (referring to step 411. Correspondingly, for a column to be queried which does not have a matching attribute in the data rows of the data source to be queried, a value of the column to be queried may be written as a null value (referring to step 412). The data source to be queried is traversed row by row according to the foregoing manner, until traversing of the data source to be queried is completed. When traversing of the data source to be queried is completed, all attributes and attribute values that are read are the data to be queried.

Because performing computation on the data to be queried requires that the data to be queried conforms to a particular data schema, in step 304 of FIG. 3 and step 413 of FIG. 4, the data to be queried may be assembled according to the constructed data schema, so that the data to be queried is stored according to the data schema, that is, data stored according to the constructed data schema is obtained. The data schema of the assembled data to be queried is the same as the foregoing constructed data schema.

Further, in step 305, a computing operation may be performed, based on the constructed data schema and the query request, on the data stored according to the data schema (that is, the assembled data to be queried), to obtain a query result. The type of the computing operation is determined by the query request. If the query request is an aggregation query, the computing operation is an aggregation operation, for example, determining an average value, a maximum value, or a minimum value. If the query request is a join query, the computing operation may be a join operation or the like.

In this embodiment, a data schema of data to be queried may be constructed via a query request, and the data to be queried may be assembled according to the constructed data schema. In this way, a computing operation can be performed, based on the query request and the data schema, on the data to be queried stored in the constructed data schema, to obtain a query result, thereby implementing schema on read. This data query manner does not require data to be written according to a fixed data schema, which can improve data flexibility. In addition, the schema on read can satisfy computation and analysis requirements, and improve data computing capability of the database, therefore, improving the computing capability of the database while ensuring the data flexibility of the database.

In some embodiments of the present application, when a computing operation is performed, based on the data schema constructed based on above and the query request, on the data stored according to the constructed data schema (that is, the assembled data to be queried), an execution plan may be generated based on the constructed data schema and the abstract syntax tree corresponding to the query request, and the computing operation may be performed, based on the execution plan, on data stored according to the constructed data schema (that is, the data to be queried assembled according to the constructed data schema), to obtain the query result.

Specifically, the execution plan may include: a logic execution plan and a physical execution plan. Correspondingly, the generating the execution plan according to the constructed data schema and the abstract syntax tree corresponding to the query request may be implemented as: step 405 and step 406 in FIG. 4. Specifically, as shown in step 405, nodes of the abstract syntax tree may be bound with metadata of a table described by the data schema, based on the constructed data schema, to obtain a logic execution plan. The metadata of the table may include: an attribute of the column to be queried (that is, a column name), a data type of the column to be queried, or the like. Specifically, check may be sequentially performed on the nodes of the abstract syntax tree, and the metadata describing the table in the constructed data schema may be bound to the nodes of the abstract syntax tree to obtain the logic execution plan. In some embodiments, the logic execution plan may further be optimized.

Further, in step 406, the physical execution plan may be generated based on the storage distribution information of the data source to be queried and the logic execution plan; and in step 414, the corresponding computing operation is performed, based on the physical execution plan, on data stored according to the constructed data schema (that is, the data to be queried assembled according to the constructed data schema), to obtain the query result.

It should be noted that step 303 and step 304 and specific implementations thereof may be implemented by the node (for example, an executor in the query engine) executing the physical execution plan in step 414.

After the query result is obtained, the query result may be returned to the client sending the query request. The client may output the query result.

In some embodiments of the present application, to reduce the memory consumption of a node where the query engine is located, a life cycle of the constructed data schema may be bound with the current query request, and after the query result corresponding to the query request is obtained, the constructed data schema can be destroyed (referring to step 415 in FIG. 4), and when a new query request arrives, a new data schema can be constructed in the foregoing data access manner, thereby implementing automatic schema on read.

It needs to be noted that, execution entities of the steps of the method provided in the foregoing embodiments may be a same device, or different devices may act as the execution entities of the method. For example, the execution entity of steps 304 and 305 may be a device A. Still for example, the execution entity of step 304 may be a device A, and the execution entity of step 305 may be a device B; and so on.

In addition, some processes described in the foregoing embodiments and accompanying drawings include a plurality of operations that appear in a particular sequence. However, it should be clearly understood that these operations may not be performed in the sequence in which the operations appear in this specification or may be performed in parallel. Sequence numbers of the operations, such as 304 and 305, are merely used for distinguishing different operations, and the sequence numbers do not indicate any execution sequence. In addition, the procedures may include more or fewer operations, and these operations may be performed in sequence or in parallel.

It should be further noted that user information (including, but not limited to, user equipment information, user personal information, or the like) and data (including, but not limited to, data for analysis, stored data, displayed data, or the like) involved in this application are all information or data authorized by the user or fully authorized by all parties, and the collection, use, and processing of related data need to comply with relevant laws, regulations, and standards of relevant countries and regions; and a corresponding operation entry is provided for the user to select to authorize or reject.

Correspondingly, an embodiment of the present application further provides a computer-readable storage medium storing computer instructions, where the computer instructions, when executed by one or a plurality of processors, cause the one or a plurality of processors to perform the steps in the foregoing data query method.

An embodiment of the present application further provides a computer program product, including: a computer program. The computer program is executed by a processor to implement steps in the foregoing data query method. In the embodiment of the present application, a specific implementation form of the computer program product is not limited. In some embodiments, the computer program product may be implemented as a query engine, a data processing system for a database, or the like.

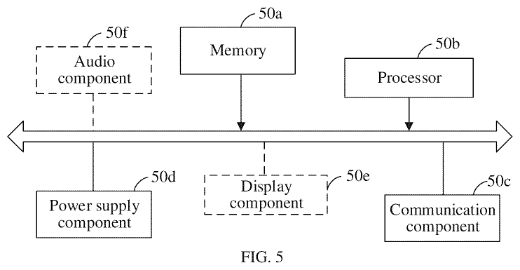

FIG. 5 is a schematic structural diagram of a computing device according to an embodiment of this application. As shown in FIG. 5, the computing device includes: a memory 50a and a processor 50b. The memory 50a is configured to store a computer program.

The processor 50b is coupled to the memory 50a and configured to execute the computer program to: obtain a query request, where data of a data source to be queried corresponding to the query request in stored in a non-fixed schema; construct, based on the query request, a data schema of data to be queried corresponding to the query request; read, from the data source to be queried, the data to be queried; assemble, based on the constructed data schema, the data to be queried, to obtain data stored according to the constructed data schema; and perform, based on the data schema and the query request, a computing operation on the data stored according to the data schema, to obtain a query result.

In some embodiments, when constructing, based on the query request, the data schema of the data to be queried corresponding to the query request, the processor 50b is specifically configured to: parse the query request to obtain an abstract syntax tree; and construct the data schema based on the abstract syntax tree.

Further, when constructing the data schema based on the abstract syntax tree, the processor 50b is specifically configured to: determine, based on the abstract syntax tree, the data source to be queried and an attribute of a column to be queried, data stored in the column to be queried including the data to be queried; determine a data type of the column to be queried; and construct the data schema based on storage distribution information of the data source to be queried, the attribute of the column to be queried, and the data type of the column to be queried.

Optionally, when determining the data type of the column to be queried, the processor 50b is specifically configured to: determine, based on the attribute of the column to be queried, the data type of the column to be queried; and/or perform semantic analysis on the query request to obtain a clause included in the query request; determine, based on the clause included in the query request, a function and/or an operation expression operating on the column to be queried; and determine, based on the function and/or the operation expression operating on the column to be queried, the data type of the column to be queried.

Further, when determining, based on the function and/or the operation expression operating on the column to be queried, the data type of the column to be queried, the processor 50b is specifically configured to: determine an input parameter type compatible with the function operating on the column to be queried; determine, based on the input parameter type compatible with the function, a data type of the column to be queried; and/or determine, based on a logic expression operating on the column to be queried, the data type of the column to be queried.

In some other embodiments, when reading, from the data source to be queried, the data to be queried, the processor 50b is specifically configured to: scan, in a row scanning manner and based on the attribute of the column to be queried, the data of the data source to be queried; and read, from the scanned data row, data whose attribute matches the attribute of the column to be queried, as the data to be queried.

In still some other embodiments, when performing, based on the data schema and the query request, computation on the data stored according to the data schema, the processor 50b is specifically configured to: generate an execution plan based on the data schema and the abstract syntax tree corresponding to the query request; and perform, based on the execution plan, computation on the data stored according to the data schema to obtain the query result.

Optionally, the execution plan includes: a logic execution plan and a physical execution plan. Correspondingly, when generating the execution plan based on the data schema and the abstract syntax tree corresponding to the query request, the processor 50b is specifically configured to: bind, based on the data schema, nodes of the abstract syntax tree to metadata of a table described by the data schema, to obtain a logic execution plan; and generate the physical execution plan based on the storage distribution information of the data source to be queried and the logic execution plan.

Responsively, when performing, based on the execution plan, the computing operation on the data stored according to the data schema, the processor 50b is specifically configured to: perform, based on the physical execution plan, a computing operation corresponding to the physical execution plan on the data stored according to the data schema, to obtain the query result.

In some embodiments, the processor 50b is further configured to: destroy the constructed data schema after the query result is obtained.

In some optional implementations, as shown in FIG. 5, the computing device may further include: components such as a communication component 50c and a power supply component 50d. In some embodiments, the computing device may be implemented as a terminal device such as a computer or a mobile phone. Correspondingly, the computing device may further include: components such as a display component 50e and an audio component 50f. Only some components are schematically provided in FIG. 5, which does not mean that the computing device necessarily includes all the components shown in FIG. 5, nor does it mean that the computing device can only include the components shown in FIG. 5.

According to the computing device provided in this embodiment of the present application, the data schema of the data to be queried may be constructed via the query request, and the data to be queried is assembled according to the constructed data schema. In this way, the computing operation can be performed, based on the query request and the data schema, on the data to be queried stored in the constructed data schema, to obtain the query result, thereby implementing schema on read. This data query manner does not require data to be written according to a fixed data schema, which can improve data flexibility. In addition, the schema on read can satisfy computing and analysis requirements, and improve data computing capability of the database, therefore improving the computing capability of the database while ensuring the data flexibility of the database.

In an embodiment of the present application, the memory is configured to store a computer program, and may be configured to store various other data to support operations on the device in which the memory is located. The processor may execute the computer program stored in the memory to implement corresponding control logic. The memory may be implemented by any type of volatile or non-volatile storage device or a combination thereof, such as a static random-access memory (Static Random-Access Memory, SRAM), an electrically erasable programmable read only memory (Electrically Erasable Programmable Read Only Memory, EEPROM), an erasable programmable read only memory (Electrical Programmable Read Only Memory, EPROM), a programmable read only memory (Programmable Read Only Memory, PROM), a read only memory (Read Only Memory, ROM), a magnetic storage, a flash memory, a magnetic disk, or an optical disc.

In an embodiment of this application, the processor may be any hardware processing device capable of executing logic of the foregoing method. Optionally, the processor may be a central processing unit (Central Processing Unit, CPU), a graphics processing unit (Graphics Processing Unit, GPU), or a microcontroller unit (Microcontroller Unit, MCU); or may be a programmable device such as a field-programmable gate array (Field-Programmable Gate Array, FPGA), a programmable array logic device (Programmable Array Logic, PAL), a general array logic device (General Array Logic, GAL), or a complex programmable logic device (Complex Programmable Logic Device, CPLD); or an application specific integrated circuit (Application Specific Integrated Circuit, ASIC) chip; or advanced reduced instruction set (Reduced Instruction Set Compute, RISC) machines (Advanced RISC Machines, ARM), a system on chip (System on Chip, SoC), or the like, but this application is not limited thereto.

In an embodiment of the present application, the communication component is configured to facilitate communication between a device at which the communication component is located and another device in a wired or wireless manner. The device at which the communication component is located may access a wireless network based on a communication standard, such as wireless fidelity (WiFi), 2G or 3G, 4G, 5G, or a combination thereof. In an exemplary embodiment, the communication component receives a broadcast signal or broadcast related information from an external broadcast management system through a broadcast channel. In an exemplary embodiment, the communication component may further be implemented based on a near field communication (Near Field Communication, NFC) technology, a radio frequency identification (Radio Frequency Identification, RFID) technology, an infrared data association (Infrared Data Association, IrDA) technology, an ultra wide band (Ultra Wide Band, UWB) technology, a Bluetooth (Bluetooth, BT) technology, or another technology.

In an embodiment of the present application, the display component may include a liquid crystal display (Liquid Crystal Display, LCD) and a touch panel (Touch Panel, TP). If the display component includes a touch panel, the display component may be implemented as a touchscreen, to receive an input signal from a user. The touch panel includes one or a plurality of touch sensors to sense a touch, a slide, and a gesture on the touch panel. The touch sensor not only can sense a boundary of a touch or slide operation, but also can detect duration and pressure related to the touch or slide operation.

In an embodiment of the present application, the power supply component is configured to provide power to various components of a device in which the power supply component is located. The power supply component may include a power supply management system, one or a plurality of power supplies, and other components associated with generating, managing, and allocating power for a device in which the power supply component is located.

In an embodiment of the present application, the audio component may be configured to output and/or input an audio signal. For example, the audio component includes a microphone (Microphone, MIC). When a device where the audio component is located is in an operation mode, such as a calling mode, a recording mode, and a speech recognition mode, and the microphone is configured to receive an external audio signal. The received audio signal may be further stored in a memory or sent by using a communication component. In some embodiments, the audio component further includes a speaker, configured to output an audio signal. For example, for a device having a language interaction function, voice interaction with a user may be implemented by using an audio component.

It needs to be noted that, the descriptions such as “first” and “second” in this specification are used to distinguish different messages, devices, modules, or the like, do not indicate a sequential order, and do not limit that the “first” and “second” are of different types.

A person skilled in the art can understand that the embodiments of the present application may be provided as a method, a system, or a computer program product. Therefore, this application may use a form of hardware-only embodiments, software-only embodiments, or embodiments combining software and hardware. Moreover, a form of a computer program product implemented on one or a plurality of computer-available storage media (including, but not limited to, a disk storage device, a compact disc read (Compact Disc Read-Only Memory CD-ROM), an optical memory, or the like) including computer-usable program code may be used in this application.

The present application is described in combination with the flowcharts and/or block diagrams of the method, device (or system), and computer program product according to the embodiments of the present application. It should be understood that computer program instructions can implement each procedure and/or block in the flowcharts and/or block diagrams and a combination of procedures and/or blocks in the flowcharts and/or block diagrams. These computer program instructions may be provided to a general-purpose computer, a special-purpose computer, an embedded processor, or a processor of another programmable data processing device to generate a machine, so that an apparatus configured to implement functions specified in one or a plurality of procedures in the flowcharts and/or one or a plurality of blocks in the block diagrams is generated by using instructions executed by the computer or the processor of another programmable data processing device.

These computer program instructions may alternatively be stored in a computer-readable memory that can instruct a computer or another programmable data processing device to work in a particular manner, so that the instructions stored in the computer-readable memory generate an article of manufacture that includes an instruction apparatus. The instruction apparatus implements a designated function in one or a plurality of procedures in the flowcharts and/or in one or a plurality of blocks in the block diagrams.

These computer program instructions may further be loaded onto a computer or another programmable data processing device, so that a series of operation steps are performed on the computer or the another programmable device, thereby generating computer-implemented processing. Therefore, the instructions executed on the computer or the another programmable device provide steps for implementing a designated function in one or a plurality of processes in the flowcharts and/or in one or a plurality of blocks in the block diagrams.

In a typical configuration, the computing device includes one or a plurality of processors (for example, CPU), an input/output interface, a network interface, and a memory.

The memory may include a non-persistent memory in a computer-readable medium, a random-access memory (Random-Access Memory, RAM), and/or a non-volatile memory, such as a read only memory (Read Only Memory, ROM) or a flash RAM (Flash RAM). The memory is an example of the computer-readable medium.

The storage medium of the computer is a readable storage medium, or may be referred to as a readable medium. The readable storage medium includes a permanent and non-permanent, removable and non-removable medium, and may implement information storage by using any method or technique. The information may be a computer-readable instruction, a data structure, a program module, or other data. Examples of the storage medium for a computer include, but are not limited to, a phase-change memory (Phase-Change Memory, PRAM), a static random access memory (SRAM), a dynamic random access memory (Dynamic Random Access Memory, DRAM), other types of random access memory (RAM), read-only memory (ROM), electrically erasable programmable read-only memory (EEPROM), or flash memory, or other memory technique, compact disc read-only memory (CD-ROM), digital video disc (Digital Video Disc, DVD), or other optical storage, magnetic tape cartridges, magnetic disk storage, or other magnetic storage devices, or any other non-transmission medium that can be used to store information that can be queried by a computing device. As defined herein, the computer-readable medium does not include transitory computer readable media (Transitory Media), such as a modulated data signal and a carrier wave.

It should be further noted that the terms “comprise”, “include”, or any other variant thereof are intended to encompass non-exclusive inclusions such that a process, method, commodity, or device including a series of elements includes not only those elements, but also other elements not explicitly listed, or also includes elements inherent to such process, method, commodity, or device. Without further limitation, the elements defined by the sentence “including a . . . ” do not preclude the existence of other identical elements in the process, method, commodity, or device including the elements.

The foregoing descriptions are only embodiments of the present application and are do not intended to limit this application. For a person skilled in the art, various modifications and variations can be made to the present application. Any modification, equivalent replacement, or improvement made without departing from the spirit and principle of the present application shall fall within the scope of the claims of this application.

1. A data query method, comprising:
obtaining a query request, wherein data of a target data source corresponding to the query request is stored in a non-fixed schema;
constructing, based on the query request, a data schema of target data corresponding to the query request;
reading, from the target data source, the target data;
assembling, according to the data schema, the target data to obtain structured data stored according to the data schema; and
performing, based on the data schema and the query request, a computing operation on the structured data to obtain a query result.

2. The method according to claim 1, wherein the constructing, based on the query request, the data schema of target data corresponding to the query request comprises:
parsing the query request to obtain an abstract syntax tree; and
constructing the data schema based on the abstract syntax tree.

3. The method according to claim 2, wherein the constructing the data schema based on the abstract syntax tree comprises:
determining, based on the abstract syntax tree, the target data source and an attribute of a target column, wherein data stored in the target column comprises the target data;
determining a data type of the target column; and
constructing the data schema based on storage distribution information of the target data source, the attribute of the target column, and the data type of the target column.

4. The method according to claim 3, wherein the determining the data type of the target column comprises:
determining, based on the attribute of the target column, the data type of the target column;
and/or
performing semantic analysis on the query request to obtain a clause comprised in the query request; determining, based on the clause comprised in the query request, a function and/or an operation expression operating on the target column; and determining, based on the function and/or the operation expression operating on the target column, the data type of the target column.

5. The method according to claim 3, wherein the reading, from the target data source, the target data comprises:
scanning, in a row scanning manner and based on the attribute of the target column, the data of the target data source; and
reading, from the scanned data, data whose attribute matches the attribute of the target column, as the target data.

6. The method according to claim 2, wherein the performing, based on the data schema and the query request, the computing operation on the structured data comprises:
generating an execution plan based on the data schema and the abstract syntax tree corresponding to the query request; and
performing, based on the execution plan, a computing operation on the structured data to obtain the query result.

7. The method according to claim 6, wherein the execution plan comprises: a logic execution plan and a physical execution plan; the generating an execution plan based on the data schema and the abstract syntax tree corresponding to the query request comprises:
binding, based on the data schema, nodes of the abstract syntax tree to metadata of a table described by the data schema, to obtain a logic execution plan; and
generating the physical execution plan based on storage distribution information of the target data source and the logic execution plan.

8. The method according to claim 7, wherein the performing, based on the execution plan, a computing operation on the structured data comprises:
performing, based on the physical execution plan, a computing operation corresponding to the physical execution plan on the structured data, to obtain the query result.

9. The method according to claim 1, further comprising:
destroying the data schema after the query result is obtained.

10. A database system, comprising:
a data source; the data source comprising: a target data source corresponding to a query request, wherein data of the target data source is stored in a non-fixed schema; and
a query engine configured to perform steps comprising:
obtain a query request, wherein data of a target data source corresponding to the query request is stored in a non-fixed schema;
construct, based on the query request, a data schema of target data corresponding to the query request;
read, from the target data source, the target data;
assemble, according to the data schema, the target data to obtain structured data stored according to the data schema; and
perform, based on the data schema and the query request, a computing operation on the structured data to obtain a query result.

11. A computing device, comprising: a memory and a processor, wherein the memory is configured to store a computer program;
the processor is coupled to the memory and configured to execute the computer program to perform operations comprising:
obtain a query request, wherein data of a target data source corresponding to the query request is stored in a non-fixed schema;
construct, based on the query request, a data schema of target data corresponding to the query request;
read, from the target data source, the target data;
assemble, according to the data schema, the target data to obtain structured data stored according to the data schema; and
perform, based on the data schema and the query request, a computing operation on the structured data to obtain a query result.

12. A non-transitory computer-readable storage medium storing computer instructions, wherein the computer instructions, when executed by one or a plurality of processors, cause the one or the plurality of processors to perform steps in the method according to claim 1.

13. The database system according to claim 10, wherein the query engine is configured to:
parse the query request to obtain an abstract syntax tree; and
construct the data schema based on the abstract syntax tree.

14. The database system according to claim 13, wherein the query engine is configured to:
determine, based on the abstract syntax tree, the target data source and an attribute of a target column, wherein data stored in the target column comprises the target data;
determine a data type of the target column; and
construct the data schema based on storage distribution information of the target data source, the attribute of the target column, and the data type of the target column.

15. The database system according to claim 14, wherein the query engine is configured to:
determine, based on the attribute of the target column, the data type of the target column;
and/or
perform semantic analysis on the query request to obtain a clause comprised in the query request; determine, based on the clause comprised in the query request, a function and/or an operation expression operating on the target column; and determine, based on the function and/or the operation expression operating on the target column, the data type of the target column.

16. The database system according to claim 14, wherein the query engine is configured to:
scan, in a row scanning manner and based on the attribute of the target column, the data of the target data source; and
read, from the scanned data, data whose attribute matches the attribute of the target column, as the target data.

17. The computing device according to claim 11, wherein the processor is further configured to:
parse the query request to obtain an abstract syntax tree; and
construct the data schema based on the abstract syntax tree.

18. The computing device according to claim 17, wherein the processor is further configured to:
determine, based on the abstract syntax tree, the target data source and an attribute of a target column, wherein data stored in the target column comprises the target data;
determine a data type of the target column; and
construct the data schema based on storage distribution information of the target data source, the attribute of the target column, and the data type of the target column.

19. The computing device according to claim 18, wherein the processor is further configured to:
determine, based on the attribute of the target column, the data type of the target column;
and/or
perform semantic analysis on the query request to obtain a clause comprised in the query request; determine, based on the clause comprised in the query request, a function and/or an operation expression operating on the target column; and determine, based on the function and/or the operation expression operating on the target column, the data type of the target column.

20. The computing device according to claim 18, wherein the processor is further configured to:
scan, in a row scanning manner and based on the attribute of the target column, the data of the target data source; and
read, from the scanned data, data whose attribute matches the attribute of the target column, as the target data.
